(19) United States
(12) Patent Application Publication
(10) Pub. No.: US 2015/0260326 A1
(43) Pub. Date: Sep. 17, 2015

(54) ELECTRICALLY HEATABLE MEDIA LINE, AND METHOD FOR PRODUCING SUCH A MEDIA LINE

(71) Applicant: VOSS AUTOMOTIVE GMBH, Wipperfürth (DE)

(72) Inventors: Jörg Westmeier, Krefeld (DE); Daniel De Beer, Engelskirchen (DE); Otfried Schwarzkopf, Kurten (DE)

(21) Appl. No.: 14/434,964

(22) PCT Filed: Oct. 14, 2013
(86) PCT No.: PCT/EP2013/003090

§ 371 Date: Apr. 10, 2015

(30) Foreign Application Priority Data
Oct. 12, 2012 (DE) 10 2012 020 055.2

(51) Int. Cl. F16L 53/00

(52) U.S. Cl. CPC F16L 53/008

(57) ABSTRACT

An electrically heatable media line including a pipeline with at least two electric conductors embedded into the wall of the pipeline, electric lines, and at least one fluidic contoured connection section. The contoured connection section is injection molded in a bonded manner around the pipeline together with the electric conductors and connection points on the electric conductors, said connection points being used to connect to the electric lines. The electric lines are bonded to the conductors, and the contoured connection section forms a contoured fluidic and electric connection section, the contoured connection section sealingly surrounding the electric connection points, a portion of the electric lines, and the end face of the pipeline wall. A method for producing an electrically heatable media line is also disclosed.

### FIELD OF THE INVENTION

The invention relates to an electrically heatable media line with a pipeline with at least two electrical conductors embedded in its wall, electrical supply cables, and with at least one fluid mechanical contoured connecting section, wherein the contoured connecting section is arranged around the pipeline together with the electrical conductors and connection points on the electrical conductors, which serve to connect with electrical supply cables, together with a method for the manufacture of such an electrically heatable media line with at least one contoured connecting section.

### BACKGROUND OF THE INVENTION

Electrically heatable media lines, together with methods for the manufacture of the same, are of known prior art. For example, DE 10 2010 051 550 A1 discloses a fabricated electrically heatable media line with at least one pipeline section with an integrated electrically conductive device, and with at least one connection device, in particular a plug, screw, or coupling device. The pipeline section and the electrically conductive device extend as far as, or near to, the end of the connecting device facing away from the pipeline section, or near to, ahead of, or in, a contoured connecting section. For the manufacture of the media line the pipeline section is provided with the electrically conductive device, in an end region of the pipeline section the integrated electrically conductive device, i.e. its contact conductors, is exposed, electrical contact is permanently made with the latter by means of a contact device, and the contact device is led out onto the outer surface of the pipeline section for purposes of connecting to an electrical energy source. The connecting device is joined onto the end region of the pipeline section, or is joined to or onto by means of primary shaping or material bonding. After the exposure of the internally located integrated conductive devices, which are disclosed in the form of electrical conductors or heating conductors, these are connected with connecting elements, which after the provision of the end region of the pipeline section with the contoured connecting section project from the outer end face of the latter, there to be connected with a connecting plug or another connecting device.

With the structure of heatable media line described in this prior art, there is no guarantee, in particular in the region of the contact device, that is to say, of the electrical supply cables to the electrically conductive device of the pipeline, that after the application of the contoured connecting section, i.e. of the connecting device, a sealed connection can actually be created. If the connection is not completely sealed and remains in operation, a state that can be caused by vibration and thermal shock, the media flowing through the pipeline and/or, condensate forming, in particular in the event of temperature fluctuations, can penetrate into the electrical part of the heatable media line, and there can lead on the one hand to corrosion and on the other hand to the failure of the facility to heat the media line electrically. Here a thermal shock is to be understood to be a rapid, impulsive alteration of the temperature in the contoured connecting section, which leads to mechanical stresses between the outer and inner parts of the contoured connecting section, since the heat is transferred to or removed from the surface faster than to or from the interior. If the stresses thus arising exceed a critical value, the result can be damage to the material.

### SUMMARY OF THE INVENTION

The object underlying the present invention is therefore to upgrade a heatable media line with a pipeline with at least two electrical conductors embedded in its wall, electrical supply cables, and with at least one fluid mechanical contoured connecting section, wherein the contoured connecting section is arranged around the pipeline together with the electrical conductors and connection points on the electrical conductors, which serve to provide the connection with electrical supply cables, together with a method for the manufacture of such a heatable media line, comprising at least one contoured connecting section, to the effect that the electrical supply cables to the electrical conductors, as the electrically conductive device of the pipeline, or media line, together with the latter as a media-carrying part, are or will be accommodated inside the contoured connecting section, totally sealed with respect to the medium flowing, or which can flow, through the pipeline, or media line, and totally sealed against environmental influences, such as moisture.

The object is achieved for an electrically heatable media line, in accordance with a pipeline with at least two electrical conductors embedded in its wall, electrical supply cables, and with at least one fluid mechanical contoured connecting section, wherein the contoured connecting section is arranged around the pipeline together with the electrical conductors and connection points on the electrical conductors, which serve to provide the connection with electrical supply cables, in that the electrical supply cables are materially bonded with the conductors, and the contoured connecting section forms a contoured connecting section in both fluid mechanical and electrical terms, whereby the contoured connecting section surrounds the electrical connection points, a section of the electrical supply cables, and the end face of the pipeline wall, in a sealed manner. For a method for manufacturing an electrically heatable media line comprising at least one contoured connecting section, the object is achieved in that a pipeline with at least two embedded electrical conductors is provided and cut to length, the electrical conductors are exposed, electrical supply cables are materially bonded to the exposed conductors, the pipeline with the electrical supply cables attached is laid into an injection molding tool and positioned; and a fluid mechanical and electrical contoured connecting section is generated in the injection molding tool, wherein the pipeline wall is also surrounded and sealed on its end face by the contoured connecting section, applied at the end by means of materially bonded overmolding, and the contoured connecting section surrounds a section of the electrical supply cables in a sealed manner. Developments of the invention are defined in the dependent claims.

By this means a heatable media line is created, in which in the first instance the electrically conductive device, integrated into the advantageously multi-layered wall of the pipeline, exposed in the form of at least two embedded electrical conductors at the desired contact points, i.e. in the desired contact region, is materially bonded with the electrical supply cables and is laid, i.e. positioned, into the injection molding tool in the desired, i.e. suitable, position. The electrical conductors integrated into the pipeline wall are advantageously contact conductors, which are integrated into an electrically conductive layer, in particular consisting of a polymer material, whereby a facility to heat the layer, i.e. the pipeline, that is to say, the media line through which medium can flow, is enabled. The material bonding of the electrical conductors of the pipeline with the electrical supply cables, can take place, for example, by means of brazing or welding. Here the electrical supply cables can be directly materially bonded with the electrical conductors of the pipeline, or indirectly with the interposition of one or a plurality of line sections, which can, for example, serve as creeping flow barrier elements, as will be described further below in more detail. Here a material bonding of the electrical supply cables and the electrical conductors of the pipeline is thus in the present case to be understood as both a direct and also an indirect connection via one or a plurality of line sections that may be interposed between the electrical supply cables and the electrical conductors.

The pipeline provided with the electrical supply cables is laid into the injection molding tool in the desired orientation and positioning of both itself and the electrical supply cables. The sections of the pipeline, and in particular of the electrical supply cables, projecting from the injection molding tool are externally sealed by means of the injection molding tool. The materially bonded overmolding of the pipeline and electrical supply cables, that is to say, the section of the electrical supply cables located within the injection molding tool, takes place with at least one injection molding material so as to form the contoured connecting section. Here a contoured connecting section is to be understood to be a connecting device, contoured on its outer surface in any manner, for purposes of connecting to another device. The materially bonded overmolding is to be understood to be a material bond between the molten bounding surfaces of the connecting partners in each case, that is to say, of the pipeline and the contoured connecting section, and of the electrical supply cables and the contoured connecting section. The electrical supply cables have at least one stranded wire with at least one outer sheathing as insulation, whereby its outer surface is molten in the course of the overmolding process and enters into a material bond with the injection molding material. In the prior art, for example, of DE 10 2010 051 550 A1, this is not possible, or at least is not provided. There a connecting plug provided with electrical connecting leads, or another connecting device, is provided, which can be connected with connecting elements, which after the provision of the end region of the pipeline section with the contoured connecting section project from the outer surface of the latter. Thus no materially bonded overmolding of the electrical connecting leads, i.e. of the electrical supply cables, is provided in this prior art. By means of the materially bonded overmolding both the pipeline and also the supply cables connected with its electrical conductors, that is to say, by the creation of a materially bonded joint with the generated contoured connecting section, a sheathing for the pipeline and electrical supply cables is created in a simple manner, sealed against the penetration of moisture and/or medium by the contoured connecting section that thereby comes into being. By this means the electrical contact points are externally sealed, or packed, by the material of the injection molding that forms the contoured connecting section. The pipeline is also sealed, or packed, on its end face by being enclosed at the end with the contoured connecting section applied by means of injection molding. As a result of the seal the penetration of moisture into the interior of the contoured connecting section can be successfully prevented, even in the event of vibrations, or severe temperature fluctuations/thermal shock, to which the heatable media line is subject when in operation at the installation location, for example, when installed in a vehicle, such as a car or a truck, where condensate can occur, in particular in the event of temperature fluctuations/thermal shock. Here the term “sealed” is thus to be understood in what follows to mean sealing against the penetration of moisture and/or medium into the interior of the contoured connecting section. The contoured connecting section sheathes both the media-carrying section, that is to say the pipeline, and is therefore a fluid mechanical contoured connecting section, and also the electrical section, that is to say, the electrical supply cables, and is thus likewise an electrical contoured connecting section. The contoured connecting section therefore combines in itself both a fluid mechanical contoured connecting section and also an electrical contoured connecting section. By means of injection molding a compact sealed unit is created with minimal effort in the form of the contoured connecting section, which sheathes the media-carrying and the electrical sections in a sealed manner, and can have an outer form that can comply with customer requirements, and/or with the particular application in question. The contoured connecting section serves in particular the purpose of connecting the heatable media line to a unit, another line, or a corresponding mating contour. It can accordingly be connected with a connecting plug, or a connecting device, of the unit, or the mating contour. The generation of a material bond between an outer sheathing of the electrical supply cables and the contoured connecting section furthermore leads to a relief of any tension on the electrical supply cables, so that any damage to the latter, even by external forces, can be avoided as far as possible.

The pipeline of the heatable media line has a tubular wall that surrounds an inner cavity through which the medium can flow. The tubular wall is advantageously of a multi-layered design, and in particular has at least one, advantageously media-resistant, inner layer bounding the inner cavity of the pipeline, and above this a single- or multi-layered electrically conductive layer with the embedded electrical conductors. The inner layer is advantageously media-resistant, in order to prevent any disintegration and accordingly any passage of the sometimes aggressive media flowing through the inner cavity through the inner layer and arrival at the electrical conductors, since otherwise there is a risk of corrosion and as a consequence the failure of the facility to heat the media line. The electrical conductors can be arranged in a desired radial and/or axial location or position with respect to the conductive layer, and with a pitch defined in advance with respect to the longitudinal axis of the pipeline. The electrical conductors are advantageously arranged on at least one conductive layer, and are covered by at least one other conductive layer as a top layer. A single- or multi-layered outer layer can be applied on the at least one conductive top layer, in particular in the form of an electrical and/or thermal insulation layer.

On its outer surface the pipeline advantageously has a ribbed structure, or a corrugated contour. Furthermore, the latter is advantageously generated in that on its outer surface, that is to say on the surface located opposite to the inner cavity of the pipeline, through which the medium can flow, the pipeline wall forms projecting ribs raised along the course of the electrical conductors, which are generated by the electrical conductors. Furthermore, it is possible that on its outer surface, that is to say on the surface located opposite to the inner cavity of the pipeline, through which the medium can flow, the pipeline wall forms grooves, which follow the course of the electrical conductors. By means of the ribs or grooves there is generated on the outer surface of the pipeline a ribbed structure or a corrugated contour corresponding to the arrangement of the electrical conductors with undercuts in the axial pull direction of the contoured connecting section, i.e. in the direction of its axial extent. This serves to create an additional form fit with the contoured connecting section, which is molded onto the outer surface of the pipeline. In particular, the ribbed structure is generated in that the electrically conductive top layer, which is applied over the wound configuration of the thereunder arranged electrically conductive layer of the pipeline with the electrical conductors, is dealt with during the application such that it is applied in the manner of a film on the outer surface of both the conductors and also the layer of the pipeline, on which the conductors are arranged. This can, for example, take place by the generation of a vacuum around the pipeline during the application of the electrically conductive top layer, such that the electrically conductive top layer is applied tightly onto the surface of both the electrical conductors and also of the inner layer, on which the latter are positioned. In particular it is possible to generate the ribbed structure by means of tubular extrusion.

Instead of a tubular extrusion process a pressure extrusion process can be used to sheathe the pipeline, whereby the corrugated contour already referred to ensues, with grooves that extend along the course of the electrical conductors.

The electrically conductive layer, as already stated, advantageously comprises two layers, a first conductive layer, on which the electrical conductors are arranged, and an electrically conductive top layer for purposes of covering the electrical conductors. The first conductive layer is advantageously thinner in comparison to the electrically conductive top layer, and in particular can have a thickness of 0.1 to 0.2 mm. The electrically conductive top layer advantageously has a thickness approximately corresponding to the outer diameter of the electrical conductors; in particular, it should correspond to somewhat more than the outer diameter of the electrical conductors so as to be able to embed the latter securely. In particular the thickness of the electrically conductive top layer can be 1.2 times the outer diameter of the electrical conductors. However, the thickness of the electrically conductive top layer is advantageously small enough so as to generate the desired ribbed structure on the outer surface of the completed pipeline. The total thickness of the electrically conductive layers, which advantageously are electrically conductive plastic layers, can, for example, be 0.1 to 0.5 mm, preferably approximately 0.5 to 0.7 mm, in the case of electrical conductors with a particular outer diameter of approximately 0.5 mm that are to be covered, and an outer diameter of the pipeline of approximately 4 to 10 mm. Furthermore, the outer diameter of the electrical conductors can be 0.1 to 1 mm, in particular it can be the 0.5 mm already cited.

By the provision of an outer surface ribbed structure or a corrugated contour for the pipeline, in addition to the adhesive bonding or material bonding an additional form fit with the overmolded contoured connecting section is possible, so that the mechanical pull-off forces are significantly increased compared with those for a smooth design of the outer surface of the pipeline. Accordingly, a separation of the contoured connecting section from the pipeline with the thereon-attached electrical supply cables can be prevented. The provision of the outer surface ribbed structure or corrugated contour for the pipeline leads to an increase in the surface area, which in addition leads to the achievement of a particularly robust and secure connection against any release of the contoured connecting section from the pipeline. The connection of the overmolded contoured connecting section, which is more secure against pull-off compared with a smooth design for the surface of the pipeline, and the pipeline, provided with a ribbed structure on its outer surface, with thereon adjoined electrical supply cables, prevents any damage to the connection of the electrical supply cables with the electrical conductors of the pipeline.

For purposes of thermal insulation the pipeline can be provided with a thermal insulation device, which is at least partially accommodated by the overmolded contoured connecting section and at least partially surrounds the pipeline, in particular an insulation device in the form of tubular cladding and/or foam. In particular the insulation device in the form of tubular cladding can be designed as a corrugated tube and/or a smooth tube. The pipeline can thus be provided on its outer surface at least partially with at least one thermal insulation device, in particular an insulation device in the form of tubular cladding and/or foam, and the thermal insulation device can be laid, in an arrangement around a part of the pipeline, into the injection molding tool, and can be overmolded in the latter. In order to prevent any gaps, which may exist after the joining of the thermal insulation device onto the pipeline and the overmolding of the contoured connecting section, from allowing a medium to pass through, a gap sealant can be provided between the pipeline and the thermal insulation device before an overmolding with the contoured connecting section takes place. Furthermore an insulation device in the form of tubular cladding can in particular be pressed onto the outer surface of the pipeline provided with the ribbed structure in order to rectify any gaps that may ensue between the inner surface of the insulation device in the form of tubular cladding and the outer surface of the pipeline by virtue of the ribbed structure, that is to say, to configure the gaps to be as small as possible, and/or to seal the latter. Furthermore a calibration can take place before the overmolding process, in order to rectify the gaps, i.e. in order to enable an overmolding that is externally sealed, even in this region in which the insulation device in the form of tubular cladding is joined onto the pipeline.

For purposes of generating a sealed materially bonded assemblage the materials of the pipeline, of an outer sheathing of the electrical supply cables, and the contoured connecting section can advantageously be joined together, in particular they are the same materials, or belong to the same class of materials. In order to provide the material bonding between the contoured connecting section and the pipeline, together with the material bonding between the contoured connecting section and the electrical supply cables, that is to say, so as to generate a secure, for example, mechanically secure, material bond sealed against the penetration of moisture or medium, the materials of the pipeline and the contoured connecting section are selected such that they are matched to one another so as to generate the materially bonded assemblage, as are the materials of an outer sheathing of the electrical supply cables and the contoured connecting section. The material bond can be such that a high mechanical strength is created, whereby bounding surfaces of the overmolded elements of the pipeline and the outer sheathing of the electrical supply cables are molten in the course of the overmolding process and are joined securely in the course of the solidification of the overmolding material of the contoured connecting section. In the case of the preferred multi-layered structure of the tubular wall the end face of the outermost and the innermost layer, together with the outer surface of the outermost layer, are materially bonded with the material of the contoured connecting section. The end face of the single inner layer or plurality of inner layers arranged between the latter, such as the electrically conductive layer, on which the electrical conductors are arranged, can similarly be materially bonded with the material of the contoured connecting section. However, this is not absolutely necessary. In particular in the case in which a polyamide is provided as the material of the outermost layer of the pipeline, in particular of the electrical insulation layer or the electrically conductive top layer, the material of the sheathing of the electrical supply cables can also consist of a polyamide, as can the material of the contoured connecting section, so as to provide optimal material bonding here between the respective partners in the connection or joint, namely between the pipeline and the contoured connecting section, and between the sheathing material of the electrical supply cables and the contoured connecting section. PA12 can, for example, be used as the polyamide. The latter can in particular also be used as the material for the inner layer of the pipeline, that is to say, the media-resistant layer of the pipeline, and also for the conductive layers, whereby the latter can maintain their conductivity by means of the introduction of conductive substances, such as by the introduction of conductive carbon black, metallic powders, or other fillers that provide conductivity. The contoured connecting section can, for example, similarly consist of PA12, whereby fibrous reinforcement can be provided if so required, such as a reinforcement in terms of glass fibers, in order to increase the strength. PA12 GF30 can therefore be used as the material, for example. In the case of the above material selection the sheathing of the electrical supply cables also consists in particular of PA12. If an insulation device in the form of tubular cladding is provided for purposes of sheathing the pipeline, and/or an electrical insulation layer is applied onto the pipeline as the outermost layer, this can similarly consist of a polyamide, for example, PA12, in order to be able to enter into an optimal connection with the material of the overmolded, or to be overmolded, contoured connecting section.

Other material pairings can, for example, be polypropylene (PP) or polyethylene (PE), at least for the respective surfaces of the pipeline and the contoured connecting section that come into contact, or the sheathing of the electrical supply cables and the contoured connecting section, and also, if required, the insulation device in the form of tubular cladding. Similarly it is possible to use, for example, TPC as the material of at least the outermost layer of the pipeline, also designated as TPE-E, that is to say, a thermoplastic polyesterelastomer/thermoplastic copolyester; it can also be used for the sheathing of the electrical supply cables, and for an insulation device in the form of tubular cladding, if provided. Polybutylene terephthalate (PBT), polyethylene terephthalate (PET), polycarbonate (PC) or acrylonitrile butadiene styrene (ABS) can in this case be used, for example, as the material for the contoured connecting section, whereby the above materials can be glass fiber reinforced in each case. Polybutylene terephthalate (PBT), or polyethylene terephthalate (PET), can furthermore be used, for example, as the material for the outer layer of the pipeline, the sheathing of the electrical supply cables, and any insulation device in the form of tubular cladding that may be provided. Polybutylene terephthalate (PBT), polyethylene terephthalate (PET), polycarbonate (PC) or acrylonitrile butadiene styrene (ABS) are in this case suitable for use, for example, as the material for the contoured connecting section, whereby the above materials can be glass fiber reinforced in each case. When using TPU, also designated as TPE-U, that is to say, a thermoplastic polymer on a urethane base, as at least the outermost material of the pipeline, as a sheathing material for the electrical supply cables, and as the material for any insulation device in the form of tubular cladding that may be provided, polybutylene terephthalate (PBT), polyethylene terephthalate (PET), polycarbonate (PC), or acrylonitrile butadiene styrene (ABS), or a polyamide (PA), are particularly suitable as materials for the contoured connecting section, whereby the above materials can be glass fiber reinforced in each case. When using TBV, also designated as TPE-V, that is to say, a cross-linked thermoplastic elastomer on an olefin base, as the material for at least the outermost layer of the pipeline, or as a material for the sheathing of the electrical supply cables, and as a material for any insulation device in the form of tubular cladding that may be provided, polypropylene (PP), polyethylene (PE), polyamide (PA), polybutylene terephthalate (PBT), or polyoxymethylene (polyacetal) (POM), are particularly suitable as materials for the contoured connecting section, whereby the above materials can also be glass fiber reinforced as required. TPS, also designated as TPE-S, that is to say, a styrene block copolymer, can furthermore be used as the material for at least the outermost layer of the pipeline, the sheathing of the electrical supply cables, and also as the material for the optionally provided insulation device in the form of tubular cladding. Here polypropylene (PP), polyethylene (PE), polyamide (PA), polybuthylene terephthalate (PBT), or also polyoxymethylene (polyacetal) (POM), are suitable for use as materials for the contoured connecting section, whereby the above materials can also be glass fiber reinforced as required. When forming at least the outermost layer of the pipeline, the sheathing of the electrical supply cables, and optionally the insulation device in the form of tubular cladding, from TPA, also designated as TPE-A, that is to say, from a thermoplastic copolyamide, a polyamide is particularly suitable as the material for the contoured connecting section. All connecting partners, that is to say, the outermost layer of the pipeline, that is to say, in particular the electrically conductive top layer or the electrical insulation layer, the sheathing of the electrical supply cables, together with the optionally provided insulation device in the form of tubular cladding, and the contoured connecting section, can furthermore consist of perfluoroethylene propylene plastic (FEP), perfluoralkoxy alkane (PFA), ethylene tetrafluorethylene (ETFE), or also polytetrafluorethylene (PTFE). Furthermore other material combinations are also possible, needless to say, which enable a good material bond between the connecting partners, that is to say, the pipeline, the outer sheathing of the electrical supply cables, and the contoured connecting section, optionally together with the insulation device in the form of tubular cladding, or the outer electrical insulation layer of the pipeline.

In order to increase the strength and the quality of the material bonds, before the overmolding with the contoured connecting section the individual joint partners, that is to say, the pipeline and the outer sheathing of the electrical supply cables can be at least partially conditioned, in particular can be preheated, and/or can be provided with at least one primer or bonding agent, and/or can be surface activated, and/or the surface can be mechanically and/or chemically augmented, and/or can be provided with at least one device enabling a form fit. For example, the components of the pipeline and the outer sheathing of the electrical supply cables, and/or in addition the insulation device in the form of tubular cladding can be at least partially preheated, in particular to a temperature above the glass transition temperature. This can take place, for example, by means of the application of an electrical voltage onto the electrical conductors provided in the tubular wall, that is to say, using the pipeline's own heating device. Furthermore heating can take place from an external source, for example, with the aid of infrared radiation, flame treatment, arrangement of the pipeline with the electrical supply cables and, if appropriate, the insulation device in the form of tubular cladding, in a heating furnace, or by another form of preconditioning. Surface activation of at least a section of the surface of the respective joint partners can, for example, be provided by means of corona treatment, plasma treatment, or laser treatment. In the case of mechanical surface augmentation, for example, at least one section of the respective surface of the joint partners can be roughened or partially ground; in the case of chemical surface augmentation, for example, the surfaces of the joint partners to be respectively connected can be etched. The provision of form fits already referred to above, in terms of the ribbed structure on the outer surface of the pipeline, also leads, needless to say, to an augmentation of the latter's outer surface, such that in this case the strength of the material composite of pipeline and contoured connecting section, as already stated, can also be increased, whereby the pull-off forces rise. The load capacity and robustness of the joint created between the pipeline and the electrical supply cables that are joined to the latter and the contoured connecting section can be significantly increased compared with conventional processes as a result of the additional utilization of form fits and the other measures cited above, such that the risk of any detachment of the respective joint partners from one another can hereby be minimized.

It proves to be further advantageous to provide the electrical supply cables before the overmolding with the contoured connecting section with a creeping flow barrier device, in particular to provide the stranded wires of the electrical supply cables with an outer surface coating, and/or the outer sheathing of the electrical supply cables in a single- or multi-layered form with a polyolefin copolymer and/or a polyamide, and/or to connect at least one creeping flow barrier element with the respective electrical supply cable and to embed the creeping flow barrier element, together with the latter, into the contoured connecting section. The creeping flow barrier device serves the purpose of ensuring the functionality of the heatable media line, even in the case of media that have a particularly high tendency to seepage, such as, in particular, aqueous urea solution, for example, AdBlue®, which accordingly seep along the electrical supply cables and gain access via the latter to the electrical conductors within the tubular wall of the pipeline, and which could destroy the latter. The consequence would be the failure of the facility to heat the media line electrically. RADOX® from the company Huber+Suhner is, for example, suitable as a polyolefin copolymer. Furthermore a material based on PA12 is suitable, particularly if this material is also used for the contoured connecting section. Not only the outer sheathing of the electrical supply cables, but also the individual conductors or stranded wires of the electrical supply cables, can be provided with an appropriate coating in order to prevent the penetration of oil, water or AdBlue®, together with other fluids, into the electrical supply cables. An outer surface insulation in the form of an outer sheathing of the respective electrical supply cable, for example, with a polyolefin polymer, can be effected in a single-layer or multi-layer, for example, twin-layer, form, whereby the multi-layer or twin-layer form of embodiment is particularly suitable when hot oil is the medium flowing through the pipeline.

As a creeping flow barrier, as already referred to above, a creeping flow barrier element can be connected with the electrical supply cables and embedded with the latter into the contoured connecting section. Here therefore there is an indirect connection of the electrical supply cables with the electrical conductors of the pipeline, whereby the exposed electrical conductors of the pipeline are connected with the creeping flow barrier element, and the creeping flow barrier element, or rather, the creeping flow barrier elements, are connected with the electrical supply cables. Both the connection points of the creeping flow barrier elements with the electrical conductors of the pipeline, and also the connection points of the creeping flow barrier elements with the electrical supply cables, are advantageously accommodated in the contoured connecting section when overmolded with the latter, and are thus enclosed in the latter, sealed against the penetration of moisture or medium.

Furthermore the thermal mass of the pipeline in the section of the pipeline overmolded with the contoured connecting section is advantageously less than, or the same as, the overmolded mass of the contoured connecting section. In particular the selection of the thermal masses of the pipeline in the overmolded section and the contoured connecting section is made such that the overmolded mass of the contoured connecting section is significantly greater than the mass of the overmolded pipeline in the overmolded section.

Two electrical conductors preferably extend along the longitudinal extent of the pipeline, and are wound around the latter. Accordingly, one to two connection points are preferably provided per electrical conductor for purposes of making contact with the electrical supply cables. The connection points for the individual electrical supply cables can be provided located next to one another, that is to say, on one side of the pipeline; however, they can also be opposed to one another. In the case in which an axis of symmetry, or plane of symmetry, is positioned along the pipeline or along the electrical conductors extending along the latter in a spiral manner, contacts are preferably made in this plane of symmetry, or in the vicinity of the latter. Needless to say, the distance between connection points to the two electrical conductors, arranged next to one another on one side of the pipeline, is a function of the particular pitch and the distance between the conductors. The distance between the connection points can, for example, be from 5 to 40 mm.

In order to be able to make the contacts or connections the electrical conductors are exposed from the outer surface of the pipeline, whereby in the case of just one electrically conductive top layer covering the latter only this layer is removed, in the case in which an insulation layer is provided on the electrically conductive top layer this layer must also be removed so as to be able to make contact with the electrical conductors. The depth of the exposure is advantageously selected such that the electrical conductors are exposed, that is to say, down to the layer arranged under the latter, for the most part this is the first electrically conductive layer.

Instead of just a point-by-point exposure of connection points on the respective electrical conductors, a strip-form (linear) exposure can also be effected, which extends over a larger region on the outer surface of the pipeline, for example, over a region of 5 to 40 mm, in which not only the respective electrical conductors are exposed, but also the region of the tubular wall between them, down to the electrically conductive layer arranged under the electrical conductors.

At least one device is provided for purposes of providing the tubular wall with an end face seal. This can, in particular be provided in the form of at least one wall section of the contoured connecting section, corresponding at least to the wall thickness of the tubular wall, materially bonded with at least the innermost layer of the tubular wall, and/or in the form of a widening of an end region of the pipeline, and/or in the form of a reduction of the wall thickness of the tubular wall in an end region. By sealing the end face of the tubular wall the medium flowing through the pipeline can be prevented from gaining access to the end face of the tubular wall and there attacking the electrical conductors. In addition to destruction of the electrical conductors the often-aggressive medium could furthermore gain access to a cable loom, and there attack the electrical conductors, or via the electrical conductors of the cable loom could gain access to further devices with which the latter is connected. In order to avoid this, sealing of the end face of the tubular wall that is accommodated in the contoured connecting section proves to be advantageous. The sealing of the end face can occur by creating a wall section of the contoured connecting section on the end face of the tubular wall in the course of the injection molding process and accordingly sealing the latter. This wall section is materially bonded with the layers of the tubular wall, in particular with the innermost layer of the tubular wall. By this means a penetration of medium into the boundary region between the end face of the tubular wall and the wall section of the contoured connecting section can be avoided.

The wall thickness of the wall section of the contoured connecting section, materially bonded on the end face with at least the innermost layer of the tubular wall, has at least approximately the wall thickness of the tubular wall, that is to say, of the overall tubular wall comprising all layers, preferably more than double the wall thickness of the overall tubular wall. Accordingly, in the case of a tubular wall thickness s of s=1 to 3 mm the wall thickness h of the wall section of the contoured connecting section can be h=2 to 6 mm.

Furthermore, for an improved material bond between the wall section of the contoured connecting section and the end face of the tubular wall, heating of the components laid into the injection molding tool can take place, in particular, heating of the pipeline, and/or of the part of the injection molding tool that is arranged in the end region of the pipeline, and which comes into contact with the end of the latter. In particular, the latter can be a mandrel that is inserted into the end of the pipeline, in order to maintain an opening for the exit of medium from the end region of the pipeline that is overmolded with the contoured connecting section.

Furthermore, a particularly good material bond between the end region of the pipeline and the material of the contoured connecting section is possible if the end region of the pipeline is widened, a process that can also be designated as “bulging”. By this means it is possible to accommodate this widened end region of the pipeline in the interior of the contoured connecting section, that is to say, to overmold the end region on all sides. To enable this to happen, before the injection molding process a tool mandrel is advantageously inserted into the interior of the pipeline in its end region, such that a gap remains between the bulged, or widened, end region of the pipeline and the tool mandrel, which gap in the course of the overmolding of the end region of the pipeline is filled with the material, and thus enables an overmolding of the latter on all sides.

A further improvement of the material bond between the end region of the pipeline and the material of the contoured connecting section is possible if the wall thickness in an end region of the pipeline is reduced. The reduction takes place advantageously from the inner surface of the tubular wall, so that a conical shaping ensues towards the end of the wall. In particular the wall thickness reduction can relate simply to the reduction of the thickness of the innermost layer, the media-resistant layer, on occasion, also to the layer that is located above the latter, in particular the first electrically conductive layer of the tubular wall. The reduction can be made continuously, or in the form of a recess, such that a kind of notch is provided in the end region of the tubular wall, instead of a conical shape. In both cases an increase of the surface area available for purposes of material bonding is possible, as is in particular the generation of a gap between a tool mandrel introduced into the end regions of the pipeline and the end region of the pipeline, so that here too the gap is filled with the material and as a result the end region of the pipeline is overmolded on all sides with the material of the contoured connecting section, and hereby can be protected from penetration of what may be an aggressive medium that later flows through the pipeline under operational conditions. In order to be able to fill what may be a very acute angled gap with the overmolding material, the overmolding in this region can take place in a plurality of layers, each of which is very thin, in particular is 0.1 mm. By this means it is possible to fill and seal the gap created between the tool mandrel and the inner surface of the end region of the pipeline very well.

### BRIEF DESCRIPTION OF THE DRAWINGS

For a more detailed explanation of the invention examples of embodiment of the latter are described in more detail with the aid of the figures. In the latter:

FIG. 1 shows a perspective view of an inventive heatable media line in the region of its contoured connecting section.

FIG. 2 shows a partially transparent side view of the contoured connecting section with a part of the pipeline of the heatable media line in FIG. 1,

FIG. 3 shows a side view of an inventive pipeline,

FIG. 4 shows a side view of an inventive pipeline with dashed lines indicating the spirals of two electrical conductors for purposes of clarification, without a top layer covering the latter.

FIG. 5 shows a longitudinal sectional view of an inventive pipeline provided with three layers,

FIG. 6 shows a longitudinal sectional view of an inventive pipeline provided with four layers,

FIG. 7 shows a side view of an inventive pipeline with an electrical conductor, which is exposed over a limited region for purposes of making contact with an electrical supply cable,

FIG. 8 shows a side view of an inventive pipeline with two electrical conductors, which are exposed at two points for purposes of making contact with electrical supply cables,

FIG. 9 shows a side view of an inventive pipeline, in which an elongated contact region is exposed for purposes of connecting the electrical conductors with electrical supply cables,

FIG. 10 shows a side view of the pipeline in FIG. 7 with electrical supply cables attached to the latter, and with tubular cladding concentrically surrounding the pipeline over a subregion, and with an overmolded contoured connecting section indicated,

FIG. 11 shows a lateral detail view of a second variant of embodiment of the connection of tubular cladding and contoured connecting section;

FIG. 12 shows a lateral view of a schematic sketch of an inventive contoured connecting section with a pipeline arranged therein, whose electrical conductors are connected with two electrical supply cables, with an electrical creeping flow barrier for the latter.

FIG. 13 shows a side view of an inventive contoured connecting section with a pipeline indicated, whereby two electrical conductors of the pipeline are connected with creeping flow barrier elements, which are connected with electrical supply cables.

FIG. 14 shows a partial longitudinal sectional view of an inventive contoured connecting section with a pipeline of an inventive heatable media line,

FIG. 15 shows a partial longitudinal sectional view of an inventive contoured connecting section with a pipeline, widened at its end, of an inventive heatable media line,

FIG. 16 shows a partial longitudinal sectional view of an inventive contoured connecting section with an inventive pipeline, which has a wall thickness that decreases on the inner surface at one end,

FIG. 17 shows a detail view of the pipeline in FIG. 16.

### DETAILED DESCRIPTION OF THE INVENTION

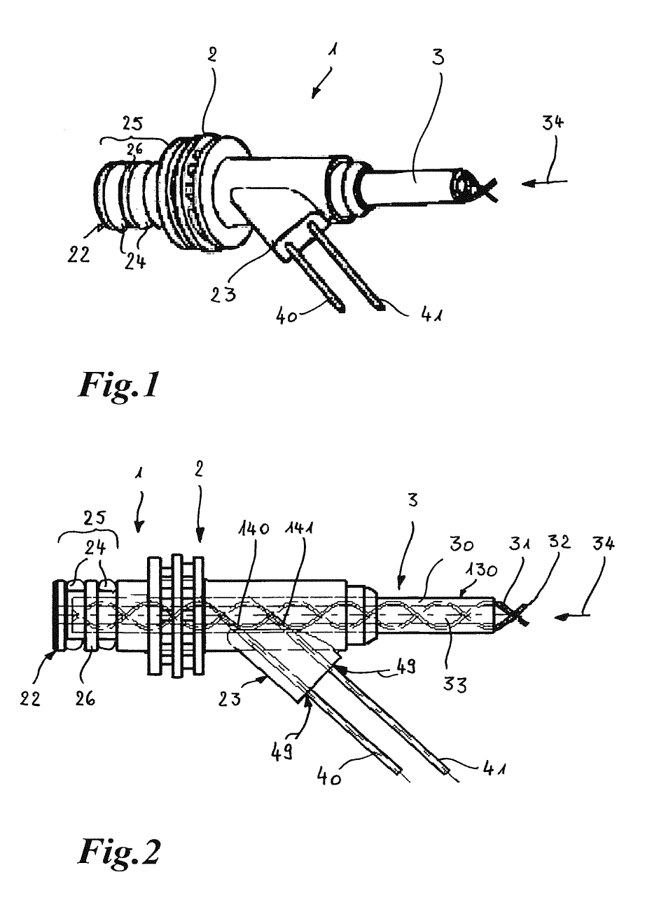

FIG. 1 shows a perspective view of part of a heatable media line 1 in the region of its contoured connecting section 2. The contoured connecting section 2 is joined to a pipeline 3 by the overmolding of the latter. The pipeline 3 serves the purpose of carrying a medium, and can therefore also be designated as a medium, or media, line. In the region of its tubular wall 30 it is provided with two electrical conductors 31, 32, as can be better seen in FIG. 2. These serve, in conjunction with the electrically conductive plastic that surrounds the latter, the purpose of enabling the pipeline to be heated, in particular for the case in which the medium flowing, or which can flow, through the inner cavity 33 of the pipeline, which is indicated in FIGS. 1 and 2 by the arrow 34, is already frozen in the cavity 33 of the pipeline, or is at risk of freezing.

As can be seen from FIG. 2, the two electrical conductors 31, 32 are connected with the two electrical supply cables 40, 41, i.e. they make contact with the latter at connection points 140, 141, and the connection points 140, 141 are overmolded in the contoured connecting section 2. By this means sealing of the part of the electrical supply cables 40, 41 accommodated in the contoured connecting section 2 and thus also of the connection points 140, 141 with the electrical conductors 31, 32 prevents any penetration of moisture and/or medium from outside the contoured connecting section 2 into the latter. At the points at which the electrical supply cables 40, 41 enter into, and exit from, the contoured connecting section 2, condensate or other moisture could otherwise gain access into the interior of the contoured connecting section 2, as is indicated by the arrows 49 in FIG. 2. For purposes of making contact with the electrical conductors 31, 32 of the pipeline 3 the latter are exposed at at least one point, and the electrical supply cables 40, 41 make contact there at the connection points 140, 141. This will be explained in more detail in what follows. As can be seen in particular in FIG. 2, the contoured connecting section 2, as an overmolding contour, forms both a fluid mechanical 22 and also an electrical contoured connecting section 23, since both the electrical supply cables 40, 41, and also the pipeline 3 are accommodated in the latter.

On the outer surface of the fluid mechanical contoured connecting section 22 at least one sealing element, in particular a sealing ring 24, can be fitted at the end, in order to be able to provide a good seal relative to a mating connector, which is connected there. The intermediate bead 26 shown in FIGS. 1 and 2 in the connecting region 25 can, depending upon the configuration of the contour of the mating connector, also be omitted. In particular the provision of just one sealing element 24 is sufficient in this case.

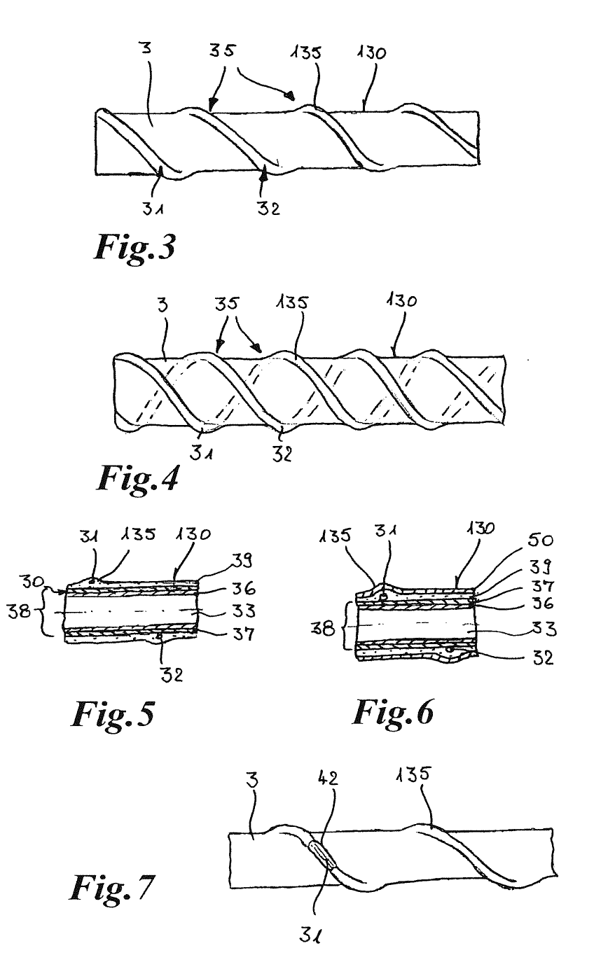

In order to enable a particularly good retention of the contoured connecting section on the outer surface of the pipeline 3, the latter is provided with a ribbed structure 35 on its outer surface, as is indicated in FIGS. 3 to 6. By this means, in addition to a force fit, an adhesive bond, and a material bond, a form fit between the two joint partners of the pipeline 3 and the contoured connecting section 2 is possible. The ribbed structure 35 is formed in that the electrical conductors 31, 32 project in a raised manner from the outer surface 130 of the tubular wall 30 of the pipeline 3 in the form of ribs 135. In particular, this shaping can be achieved in the course of the manufacture of the pipeline in that, during the application of the layer or layers covering the electrical conductors 31, 32 a vacuum is generated around the pipeline 3, such that these outer layers or layer sit tightly on the electrical conductors 31, 32, together with the layer on which the latter are arranged. This will be explained in slightly more detail further below. The pipeline 3 is thus, as indicated in FIGS. 5 and 6, firstly provided with a media-resistant inner layer 36, which bounds the inner cavity 33 of the pipeline 3. This media-resistant inner layer 36 thus makes contact with the medium flowing through the inner cavity 33 of the pipeline 3, and is accordingly designed so as not to be damaged by the latter and, furthermore, so as to prevent the medium from passing through the media-resistant inner layer 36, and in particular from gaining access to the layers that are located above the latter. A first electrically conductive layer 37 is arranged above the media-resistant inner layer 36, as can be seen from FIGS. 5 and 6. The media-resistant inner layer 36 and the first electrically conductive layer 37 together form the basic pipeline 38, on which is provided the wound configuration, here with two electrical conductors 31, 32. The two electrical conductors, 31, 32 extend around the basic pipeline 38 in the form of spirals. This is indicated in FIG. 4.

The basic pipeline 38, wound around accordingly, is covered with a further electrically conductive layer 39, as can also be seen from FIGS. 5 and 6. The electrically conductive top layer 39 can at the same time be the outermost layer of the pipeline 3, as indicated in FIG. 5. It is also possible to cover the latter with an electrical or thermal insulation layer 50, which then forms the outermost layer of the pipeline 3. This is indicated in FIG. 6.

In order to provide the electrically conductive top layer 39 such that it sits tightly on the basic pipeline 38, and also on the electrical conductors 31, 32, the basic pipeline 38 wound around with the two electrical conductors 31, 32, can firstly be heated, for example, can be subjected to flame treatment, and then introduced into a vacuum before the electrically conductive top layer 39 is extruded onto it. By virtue of the vacuum in the course of the injection process the latter sits tightly on the outer surface, on both of the two electrical conductors 31, 32, and also on the basic pipeline 38, and hence on the electrically conductive layer 37. The sheathing with the electrically conductive top layer 39 can, for example, take place using the crosshead extrusion process, in which the material of the electrically conductive top layer 39 is extruded onto the pipeline transverse to its longitudinal extent. Here the thickness of the electrically conductive layer 37 can, for example, be 0.1 to 0.2 mm, while the thickness of the electrically conductive top layer 39 can correspond approximately to the outer diameter of the electrical conductors 31, 32, or can also be somewhat thicker, that is to say, for example, thicker by a factor of 1.2. The electrical conductors 31, 32 can, for example, have an outer diameter of 0.1 to 1 mm, in particular 0.5 mm. The total wall thickness of the pipeline 3 can be, for example, 0.1 to 2.5 mm, in particular 0.5 to 0.7 mm, with a pipeline diameter of some 4 to 10 mm.

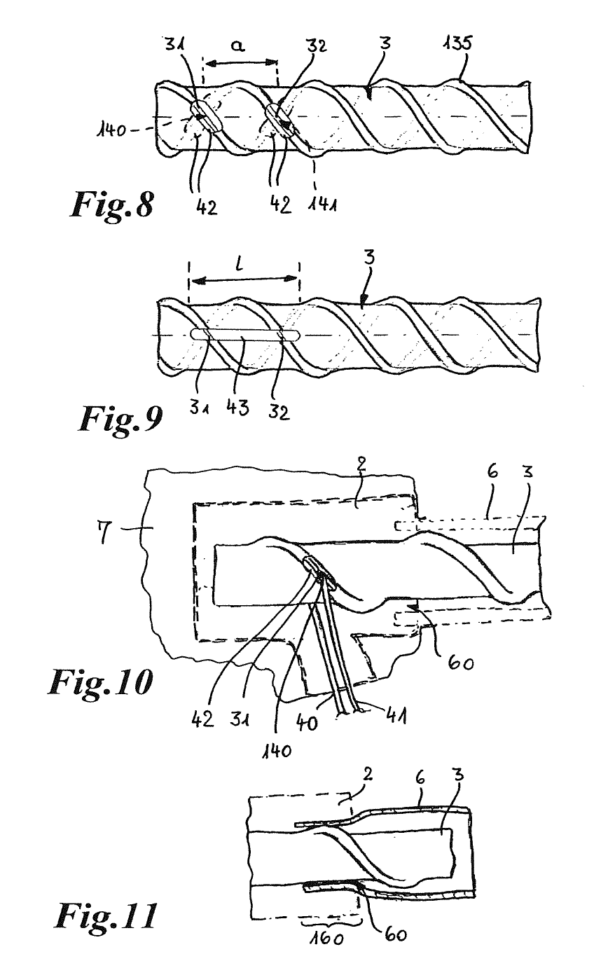

In order to be able to make contact between the two electrical conductors 31, 32, and the two supply cables 40, 41, the two electrical conductors 31, 32 are exposed in a limited region 42 or 43. This is indicated in FIGS. 7 to 9. The exposure of the two electrical conductors 31, 32 in the contact region 42 or 43 can, for example, take place by means of lasers. Other removal methods are also possible. In order to be able to make contact in the form of a material bond between the electrical conductors 31, 32, and the two electrical supply cables 40, 41, the exposure of the two electrical conductors 31, 32 preferably takes place approximately up to the electrically conductive layer 37. This is indicated in FIGS. 7 to 9. The exposure can thereby take place, with respect to the two electrical conductors 31, 32 on two opposing sides of the pipeline 3, as indicated in FIG. 7, where just the one side is shown, or located on one and the same side next to one another, as indicated in FIG. 8, or located on one and the same side in an elongated region in the form of a strip, the contact region 43, which not only extends in a point-by-point manner around the respective electrical conductors 31, 32, as does the contact region 42, but also comprises the region between the two adjacent electrical conductors 31, 32, as indicated in FIG. 9. For example, one to two contact regions 42 or connection points are provided per electrical conductor 31, 32 for purposes of connecting with the electrical supply cables 40, 41. The distance a between the possible connection points 140, 141 as shown in FIG. 8, whereby the latter are only indicated by dashed lines, where the electrical supply cables 40, 41 are connected, can, for example, be 5 to 40 mm, and is also dependent on the distance between the two electrical conductors 31, 32, which extend around the basic pipeline 38 in the form of spirals. Accordingly the elongated contact region 43 shown in FIG. 9 can likewise have a length l of some 5 to 40 mm.

If the pipeline 3 is indeed provided with the electrically conductive top layer 39, but not with an outer surface electrical insulation layer 50, only the electrically conductive top layer 39 is removed in the contact region 42 or 43 accordingly. If, on the other hand, the electrical insulation layer 50 is already arranged on the outer surface of the pipeline 3, this is removed together with the electrically conductive top layer 39 in the respective contact region 42 or 43, in order to be able to make contact between the two electrical conductors 31, 32 and the electrical supply cables 40, 41. In the case of the pipeline shown in FIG. 5, which has no thermal and/or electrical insulation layer 50 on its outer surface, thermal and/or electrical insulation can still be applied subsequently. Here, in particular, a subsequent sheathing of the outer surface can take place with a thermal and/or electrical insulation device.

For purposes of thermal insulation tubular cladding 6 can be used, as indicated in FIGS. 10 and 11. This can be designed in the form of a smooth tube and/or a corrugated tube, and can surround a part of the pipeline 3. With the provision of tubular cladding 6, the contoured connecting section 2, as also indicated in FIGS. 10 and 11, after the overmolding surrounds a part of the cladding, so as to seal the latter externally against the penetration of moisture and/or medium, such that the medium that can flow, or is flowing, through the pipeline 3, and moisture, such as condensate, does not gain access through a gap 60 between the tubular cladding 6 and the pipeline 3 into the interior of the contoured connecting section 2, and in particular, not into the region of the contact points between the electrical conductors 31, 32 and the electrical supply cables 40, 41. Otherwise there is a risk of failure of the facility to heat the pipeline electrically.

A sealant, i.e. a gap sealant, can be introduced into the gap 60 between the tubular cladding 6 and the pipeline 3, although this is not shown in FIGS. 10 and 11. Furthermore the tubular cladding 6 can be pressed onto and around the outer contour of the pipeline 3 provided with the ribbed structure 35 on its outer surface, and in this manner the gap 60 between the tubular cladding 6 and the pipeline 3 can be minimized as far as possible. The section 160 of the tubular cladding 6 that has been pressed on, that is to say, the section whose outer diameter is reduced relative to the original, or other, outer diameter of the pipeline 3, is accommodated in the overmolded outer contour 2. This variant is shown in FIG. 11. Furthermore a suitable calibration is possible, in order to match the shape and the dimensions of the tubular cladding 6 and the pipeline 3 suitably to one another, such that the occurrence of gaps 60 can be minimized as far as possible, or can be sealed.

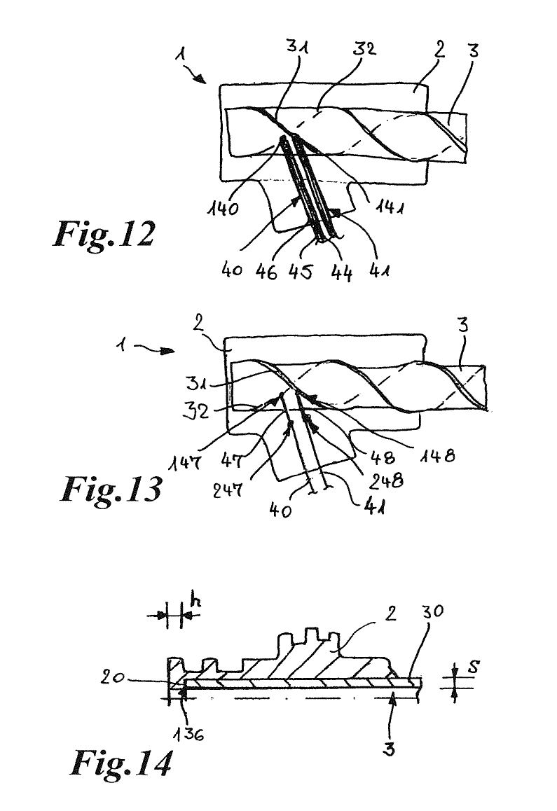

In FIGS. 12 and 13 are shown two variants of embodiment for creeping flow barrier devices, which are designed to prevent the penetration of medium via the electrical supply cables 40, 41. The variant shown in FIG. 12, in which the electrical supply cables 40, 41 are already materially bonded to the two electrical connectors 31, 32 at the connection points 140, 141, in particular by means of brazing or welding, is provided with a creeping flow barrier, to the effect that the two electrical supply cables 40, 41 either in the region of their outer sheathing 44, or around each of their stranded wires 45, as just indicated in FIG. 12, are provided with a coating 46, which serves as a creeping flow barrier. Here a polyolefin copolymer or a polyamide is particularly suitable. Such a coating prevents a medium or moisture, such as condensate, from seeping along the electrical supply cables 40, 41 and accordingly gaining access to the first and second electrical conductors 31, 32 in the interior of the tubular wall 30 and damaging them, which in particular can lead to the failure of the facility to heat the pipeline electrically.

The variant of a creeping flow barrier device shown in FIG. 13 comprises two creeping flow barrier elements 47, 48, which are connected with the first and second conductors 31, 32 at the connection points 147, 148. The two electrical supply cables 40, 41 are connected with the two creeping flow barrier elements 47, 48 at the connection points 247, 248. In this variant of embodiment the creeping flow barrier is thus achieved, in that no direct connection exists between the electrical supply cables 40, 41, protruding externally out of the contoured connecting section 2, and the electrical conductors 31, 32 in the tubular wall 30; instead the creeping flow barrier elements 47, 48 are interposed between the electrical supply cables 40, 41, and the electrical conductors 31, 32. Here a connection of the creeping flow barrier elements 47, 48 with the electrical conductors 31, 32 at the connection points 147, 148, or the creeping flow barrier elements 47, 48 with the two electrical supply cables 40, 41 at the connection points 247, 248 can also once again take the form of a material bond, that is to say, in particular by means of brazing or welding.

After the joining together, as described above, of exposed electrical conductors 31, 32 and the electrical supply cables 40, 41, if necessary with the interposition of the creeping flow barrier elements 46, 47, the combination thus prepared of pipeline 3 and electrical supply cables 40, 41 is laid into an injection molding tool 7, which is only indicated in FIG. 10, and in particular the electrical supply cables 40, 41 are arranged in the desired position. After this there takes place an overmolding with the desired contoured connecting section 2, as indicated in FIG. 10. The contoured connecting section 2 created by the overmolding process encloses on the one hand the media-carrying part of the pipeline 3 and on the other hand the electrical connecting part, that is to say, the electrical supply cables 40, 41, in one and the same contoured connecting section 2. Its outer shape can conform to the application in question and/or to the customer requirements. In the contoured connecting section 2 the media-carrying and electrical parts are accommodated in a sealed manner against any penetration of moisture and/or medium, and are protected against damage as far as possible, in particular also against any separation of the contoured connecting section 2 from the pipeline 3, and at the same time any parting of the electrical conductors 31, 32 from the supply cables 40, 41.

Before the overmolding the pipeline 3 and the outer sheathing 44 of the electrical supply cables 40, 41 are conditioned, in particular are preheated, and/or are provided with at least one primer or bonding agent, and/or are surface activated, and/or the surface is mechanically and/or chemically augmented, in order to enable an even better retention of the overmolding material for purposes of generating the contoured connecting section 2 on the pipeline 3 and the sheathing 44 of the electrical supply cables 40, 41.

FIG. 14 shows a partial longitudinal sectional view of the pipeline 3 with the injected contoured connecting section 2. For reasons of simplification the pipeline 3 is represented with just one layer, but in principle has the multi-layer structure shown in particular in FIGS. 5 and 6. The tubular wall 30 has a total wall thickness s. On the end face the pipeline 3 is also overmolded by the contoured connecting section 2, whereby a wall section 20 is formed there, which has a wall thickness h. The material bonding of the pipeline 3 on its end face 136 with the material of the contoured connecting section 2 in the region of also the wall section 20 leads to a sealing of the tubular wall 30 in the region of its end face 136. This is very important in order to avoid the medium flowing through the pipeline 3 from gaining access at the end to the electrical conductors 31, 32 (see in particular FIGS. 5 and 6) arranged in one of the layers of the tubular wall 30, and there on the one hand chemically attacking, i.e. decomposing, the latter, and on the other hand gaining access via the latter to a cable loom and damaging the latter and/or devices connected with the latter.

In order to provide a good seal the wall thickness h is at least approximately the same as the wall thickness s of the tubular wall 30, preferably h≧2s. In the case of a pipeline 3 with a wall thickness s of the tubular wall 30 of s=1 to 3 mm, in particular s=1.5 mm, for example, with a pipeline outer diameter dₐ of 6 mm, the wall thickness h of the wall section 20 can be h=2 to 6 mm, in particular h=3 to 6 mm.

For an improved material bond in the region of the end face 136 of the pipeline 3, the heating of the parts laid in the injection molding tool 7 (see FIG. 10), here in the form of the pipeline 3 and/or the injection molding tool 7, if necessary only in a subregion, for example in the region of an injection mandrel, or tool mandrel, of the injection molding tool, proves to be advantageous.

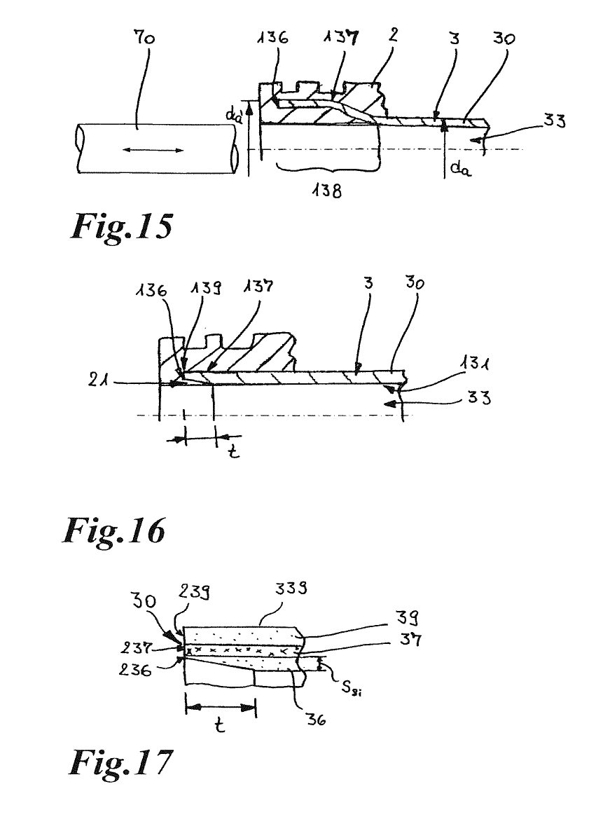

In order to ease further the process of sealing the end region 137 of the pipeline 3, and to provide a greater surface area for a material bond between the pipeline 3 and the contoured connecting section 2, the latter can, as shown in FIG. 15, be bulged, that is to say, the diameter dₐ′ can be increased relative to the outer diameter dₐ of the pipeline 3. By this means the bulged region 138 of the pipeline can be completely overmolded, such that in each case the end face 136 is securely accommodated in the material of the contoured connecting section 2, and is thereby sealed against any contact with the medium that can flow through the pipeline 3. In order to maintain the inner cavity 33 of the pipeline 3 even in the course of the overmolding of the bulged region 138, a tool mandrel 70 can be introduced into the latter before the injection process, and after the latter can be removed once again. This is also indicated in FIG. 15.

Instead of the provision of a bulged region 138 the end region 137 can be provided with a wall thickness that decreases in the direction of the end 139 of the pipeline 3, as shown in FIGS. 16 and 17. The reduction of the wall thickness is here shown in a continuous form, but can also be stepped, in particular can be formed by the provision of just one step or recess. The reduction of the wall thickness takes place from the inner surface 131 of the pipeline 3. By means of this shaping of the end region 137 of the pipeline 3 a larger surface area is available, compared with the form of embodiment shown in FIG. 14, for material bonding between the pipeline 3 and the contoured connecting section 2, and the sealing of the end region 137, that is to say, in particular of the end face 136 of the pipeline 3 is, as a result, very well enabled.

As can be seen in particular from FIG. 17, the reduction of the wall thickness of the tubular wall 30 advantageously relates to just the innermost layer of the latter, the media-resistant layer 36, on occasion, in part also to the layer located above it, which here is the first electrically conductive layer 37. The length t of the end region 137, in which the reduction of the wall thickness of the tubular wall 30 is provided, determines the size of the surface area, which is additionally available for material bonding between the pipeline 3 and the contoured connecting section 2. In the example shown in FIG. 17 the wall thickness s_{Si} of the media-resistant layer 36 is reduced approximately to zero in the region of the end face 236 of the layer 36. The overmolding material for purposes of forming the outer contour 2 is applied onto the end face 239 of the outermost layer 39, the end face 237 of the central layer 37, and the end face 236 of the innermost layer 36, and forms a material bond with the outer surface 339 of the outermost layer 39.

In order to continue the inner cavity 33 of the pipeline 3 in an even manner also in the overmolded end region 137, in the course of the overmolding process, as also stated above with respect to the bulged end region of the pipeline 3 in FIG. 15, a tool mandrel 70 can be inserted at the end into the pipeline 3, and after the overmolding process can be removed once again (this is not shown in FIGS. 16 and 17). The melt of the injection molding material can by this means be guided around the inner surface of the end region 137, and thus the gap 21 ensuing between the tool mandrel and this inner surface can be filled with the injection molding material. For example, the injection molding process can take place in a multi-layered form, for example, in four layers, each of which has a thickness of 0.1 mm, in order to enable an optimal filling of the conical gap 21 between the tool mandrel 70 and the inner surface 131 of the end region 137 of the pipeline 3.

The contoured connecting section is advantageously connected by the overmolding process, taking into account the other above-cited measures, with both the media-carrying and fluid mechanical parts of the heatable media line and the electrical part of the electrical supply cables, in a material bond, in a force fit, and in a form fit.

In addition to the variants of embodiment of heatable media lines, as described above and shown in figures, numerous others can also be formed, in which in each case the contoured connecting section is a fluid mechanical and electrical contoured connecting section formed by overmolding of the pipeline together with the electrical supply cables, materially bonded with its electrical conductors. The pipeline, together with the electrical supply cables, is provided in one step in the overmolding process with a connection with the contoured connecting section that is sealed against the penetration of moisture and/or medium, and in this manner the electrical supply cables, and also the end face of the pipeline, are also surrounded in a sealed manner against the penetration of moisture and/or medium.

### REFERENCE LIST

1 Heatable media line
2 Contoured connecting section
3 Pipeline
6 Tubular cladding
7 Injection molding tool
20 Wall
21 Gap
22 Fluid mechanical contoured connecting section
23 Electrical contoured connecting section
24 Sealing ring
25 Connecting region
26 Intermediate bead
30 Tubular wall
31 First electrical conductor
32 Second electrical conductor
33 Inner cavity
34 Arrow
35 Ribbed structure
36 Media-resistant layer
37 First electrically conductive layer
38 Base pipeline
39 Electrically conductive top layer
40 Electrical supply cable
41 Electrical supply cable
42 Contact region
43 Elongated contact region
44 Outer sheathing
45 Stranded wire
46 Coating as creeping flow barrier device
47 Creeping flow barrier element
48 Creeping flow barrier element
49 Arrow
50 Electrical insulation layer
60 Gap
70 Tool mandrel
130 Outer surface
131 Inner surface
135 Rib
136 End face of 3
137 End region
138 Bulged region
139 End of 3
140 Connection point
141 Connection point
147 Connection point
148 Connection point
160 Pressed-on section
236 End face of 36
237 End face of 37
239 End face of 39
247 Connection point
248 Connection point
339 Outer surface of 39
a Distance between two connection points 140, 141
l Length of 43
s Total wall thickness of 30
sₛᵢ Wall thickness of 36
h Wall thickness of 20
dₐ Outer diameter of 3
dₐ′ Bulged outer diameter of 3
t Length of 137

What is claimed is:

1. An electrically heatable media line, comprising: a pipeline with at least two electrical conductors embedded in its wall, electrical supply cables, and with at least one fluid mechanical contoured connecting section, wherein the contoured connecting section is arranged around the pipeline together with the electrical conductors and connection points on the electrical conductors, which serve to provide the connection with electrical supply cables, wherein the electrical supply cables are materially bonded with the conductors and the contoured connecting section forms a fluid mechanical and electrical contoured connecting section, wherein in an injected material bond the contoured connecting section surrounds the electrical connection points, a section of the electrical supply cables, and an end face of the pipeline wall.

2. The electrically heatable media line in accordance with claim 1, wherein for purposes of generating a high mechanical strength bounding surfaces of the overmolded elements of the pipeline and an outer sheathing of the electrical supply cables are molten in the course of the overmolding process, and are joined securely in the course of the solidification of the overmolding material of the contoured connecting section, in particular in the case of a multi-layered structure of the pipeline wall at least the end faces of the outermost and the innermost layer together with the outer surface of the outermost layer are materially bonded with the material of the contoured connecting section.

3. The electrically heatable media line in accordance with claim 1, wherein for purposes of generating a sealed materially bonded assemblage the materials of the pipeline, an outer sheathing of the electrical supply cables, and the contoured connecting section, are one or more of joined together, the same materials, and belong to the same class of materials.

4. The electrically heatable media line in accordance with claim 2, wherein the pipeline has a ribbed structure or a corrugated contour on its outer surface.

5. The electrically heatable media line in accordance with claim 4, wherein for purposes of generating the ribbed structure, or corrugated contour, a tubular wall on its outer surface forms raised projecting ribs or grooves along the course of the electrical conductors, in particular the ribbed structure is formed in that, during the application of the layer or layers covering the electrical conductors a vacuum is generated around the pipeline, such that these outer layers or layer sit tightly on the electrical conductors together with the layer on which the latter are arranged.

6. The electrically heatable media line in accordance with claim 1, wherein an insulation device in the form of tubular cladding is provided for purposes of sheathing the pipeline, or at least a section of the pipeline, and/or an electrical insulation layer is applied as an outermost layer onto the pipeline.

7. The electrically heatable media line in accordance with claim 4, wherein at least one thermal insulation device is provided, accommodated partially by the overmolded contoured connecting section, and at least partially surrounding the pipeline, in particular an insulation device in the form of tubular cladding and/or foam; in particular the thermal insulation device in the form of tubular cladding is pressed onto and around the outer contour of the pipeline provided with the ribbed structure or corrugated contour on its outer surface, and a gap between the tubular cladding and the pipeline is minimized as far as possible, and at least a pressed-on section of the tubular cladding is accommodated in the overmolded outer contour.

8. The electrically heatable media line in accordance with claim 1, wherein the electrical supply cables are provided with a creeping flow barrier device, in particular stranded wires of the electrical supply cables are provided with an outer surface coating and/or an outer sheathing of the electrical supply cables is provided in a single- or multi-layered form with a polyolefin copolymer and/or a polyamide, and/or at least one creeping flow barrier element is connected with the respective electrical supply cable and together with the latter is accommodated in the contoured connecting section.

9. The electrically heatable media line in accordance with claim 1, wherein for purposes of end face sealing of the tubular wall at least one wall section of the contoured connecting section is provided, corresponding at least to the wall thickness (s) of the tubular wall, and materially bonded with at least an innermost layer of the pipeline wall, and/or a widening of an end region of the pipeline is provided, and/or a reduction of the wall thickness (s) of the tubular wall in an end region is provided, in particular a reduction of the wall thickness (s) of the tubular wall originating from its inner surface, in the case of a multi-layered tubular wall a reduction of a wall thickness (s_{Si}) of at least the innermost layer of the pipeline wall, in particular of the innermost layer and a central layer.

10. The electrically heatable media line in accordance with claim 9, wherein a wall thickness (h) of the wall section of the contoured connecting section, materially bonded on its end face with at least the innermost layer of the tubular wall, has at least approximately the wall thickness (s) of the tubular wall, in particular more than double the wall thickness (s) of the tubular wall, in particular the tubular wall thickness (s) is 1 to 3 mm, and the wall thickness (h) of the wall section of the contoured connecting section is 2 to 6 mm.

11. A method for the manufacture of an electrically heatable media line, comprising at least one contoured connecting section, comprising the steps of:
providing and cutting to length a pipeline with at least two embedded electrical conductors,
exposing the electrical conductors,
materially bonding electrical supply cables with the exposed electrical conductors,
laying the pipeline with electrical supply cables attached is laid into an injection molding tool and positioned positioning the pipeline, and
generating a fluid mechanical and electrical contoured connecting section in the injection molding tool, wherein a pipeline wall is also enclosed and sealed on its end face by the contoured connecting section, applied at the end by materially bonded overmolding, and the contoured connecting section encloses a section of the electrical supply cables in a sealed manner.

12. The method in accordance with claim 11, wherein the electrical conductors are exposed in a contact region by lasers.

13. The method in accordance with claim 11, wherein the electrical conductors are exposed down to an electrically conductive layer of the tubular wall, in particular located on two opposing sides of the pipeline, or on one and the same side next to one another in a contact region extending in a point-by-point manner around the respective electrical conductors, or in an elongated strip-form contact region, also extending between the two adjacent electrical conductors.

14. The method in accordance with claim 11, wherein before the overmolding with the contoured connecting section, the pipeline is provided at least partially on its outer surface with at least one thermal insulation device, in particular an insulation device in the form of tubular cladding and/or foam, which is laid together with the pipeline into the injection molding tool, and is overmolded with the contoured connecting section.

15. The method in accordance with claim 11, wherein for purposes of achieving a particularly good material bond between the end region, of the pipeline and the material of the contoured connecting section the end region of the pipeline is widened to an outer diameter that is increased compared with an other outer diameter (dₐ) of the pipeline and this widened end region of the pipeline is accommodated in an interior of the contoured connecting section by overmolding on all sides, wherein for purposes of overmolding on all sides, in particular into the interior of the pipeline, at least in its widened end region, a tool mandrel is inserted before the injection molding process such that a gap remains between the widened end region of the pipeline and the tool mandrel, which gap in the course of the overmolding of the end region of the pipeline is filled with the injection material.

16. The method in accordance with claim 11, wherein for purposes of generating a secure sealed assemblage the materials of the pipeline, and the contoured connecting section, and of an outer sheathing of the electrical supply cables, and the contoured connecting section are selected in a coordinated manner for purposes of generating a material bond, in particular with the provision of a polyamide the latter is used as an outer material for the pipeline, as a sheathing material for the electrical supply cables, and as the material of the contoured connecting section.

17. The method in accordance with claim 11, wherein before the overmolding the pipeline and an outer sheathing of the electrical supply cables are at least partially conditioned, in particular are preheated, and/or are provided with at least one primer or bonding agent, and/or are surface activated, in particular the surface is mechanically and/or chemically augmented, and/or is provided with at least one device enabling a form fit.

18. The method in accordance with claim 11, wherein before the overmolding with the contoured connecting section the electrical supply cables are provided with a creeping flow barrier device, in particular stranded wires of the electrical supply cables are provided with an outer surface coating and/or outer sheathing of the electrical supply cables is provided in a single- or multi-layered form with a polyolefin copolymer and/or a polyamide, and/or at least one creeping flow barrier element is connected with the respective electrical supply cable and together with the latter is embedded into the contoured connecting section.

19. The method in accordance with claim 11, wherein a thermal mass of the pipeline in the overmolded section is less than, or the same as, an injected mass of the contoured connecting section.
